(19) United States
(12) Patent Application Publication
(10) Pub. No.: US 2002/0084083 A1
(43) Pub. Date: Jul. 4, 2002

(54) Cutter bar on a tillage implement

(76) Inventor: Lon William Nelson, Veradale, WA (US)

Correspondence Address: James L. Price, WELLS, ST. JOHN, ROBERTS, GREGORY & MATKIN P.S., Suite 1300, 601 W. First Avenue, Spokane, WA, 99201-3828, US

(21) Appl. No.: 09/752,220

(22) Filed: Dec. 28, 2000

(51) Int. Cl. A01D 34/03; A01B 23/00

(52) U.S. Cl. 172/624.5; 56/13.5; 172/773

(57) ABSTRACT

A ground tillage tool and a sickle bar having reciprocal cutter teeth are mounted to a frame, with the sickle being driven to reciprocate the cutter teeth in a vegetation cutting action forward of the tillage tool. The sickle bar is mounted such that may be cut by the sickle bar and the cut vegetation is engaged and fractured by the ground tillage tool as the implement is moved in a forward direction

### TECHNICAL FIELD

The present invention relates to cutting vegetation with a cutter bar and fracturing the cut vegetation with a tillage implement in a single pass over a field.

### BACKGROUND OF THE INVENTION

No till or minimum till farming has faltered in recent years in part because the stubble left after harvest will not easily decompose and add nutrients to the surrounding soil. This is due partially to the fact that the crop is not usually harvested in close proximity to the ground surface and the remaining stubble is typically left standing.

Wheat, for example includes the desired food product in heads that grow at the tops of long stalks. It is most economical to harvest just the heads since the plant stalks are not of significant value, and considerable time and energy would otherwise be expended to separate the grain from the stalk material and chaff. Thus the harvesting equipment will typically be set at a cutting height that will take the heads and a minimal length of the stalks. The remaining stubble will remain standing in the field.

It is known that decomposition of plant stalks will occur more rapidly if the stalks are fractured. Thus, many minimum or no till farmers will follow harvest with an implement such as a harrow with the intent to fracture the stalks as much as possible and thereby encourage composting of the stubble. Such action meets with only partial success since many of the standing stalks are not engaged and fractured by the harrow. Further, many of the standing stalks remain standing even when fractured and are therefor not exposed to moisture from the ground surface that encourages decomposition.

As a solution, it is possible to cut the stubble close to the ground with a conventional cutting implement, then follow the cutting operation with a harrow. This requires two separate expensive and time consuming passes over the field; one pass to cut the stubble, and another pass to harrow the cut materials.

While it is known that cut stubble will eventually decompose and add nutrients to the soil, actual decomposition will not readily occur if the stalks of the stubble are not broken. The harrow may be used to fracture at least some of the cut stalks, but the cost of energy for the extra pass through the field is significant, especially with raising fuel prices.

A need has thus been realized for an apparatus and process by which standing stubble may be cut and fractured in a single pass through a field. This need, as will be understood from the following disclosure, is fulfilled by the present invention.

### BRIEF DESCRIPTION OF THE DRAWINGS

Preferred embodiments of the invention are described below with reference to the following accompanying drawings.

FIG. 1 is a fragmented side elevation view of a preferred form of the present apparatus connected to a tractor;

FIG. 2 is an enlarged fragmented view exemplifying process steps and apparatus;

FIG. 3 is a top plan view of a preferred cutter bar and tillage implement;

FIG. 4 is a partial detail view of an exemplary cutter bar and retractable linkage in an elevated inoperative position;

FIG. 5 is a view similar to FIG. 4 only showing the cutter bar in a lowered operative position;

FIG. 6 is a diagrammatic view illustrating elevation of the cutter bar and linkage lifted above a loose link stop;

FIG. 7 is a fragmented plan view illustrating an exemplary drive for the cutter bar; and

FIG. 8 is a detail side elevation of a portion of the loose link stop.

### DESCRIPTION OF PREFERRED EMBODIMENTS

This disclosure of the invention is submitted in furtherance of the constitutional purposes of the U.S. Patent Laws “to promote the progress of science and useful arts” (Article 1, Section 8).

General Description

Before describing details of preferred exemplary forms of the invention, general aspects will be described below with reference numerals identifying general assemblies and sub-assemblies shown by way of example in the drawings.

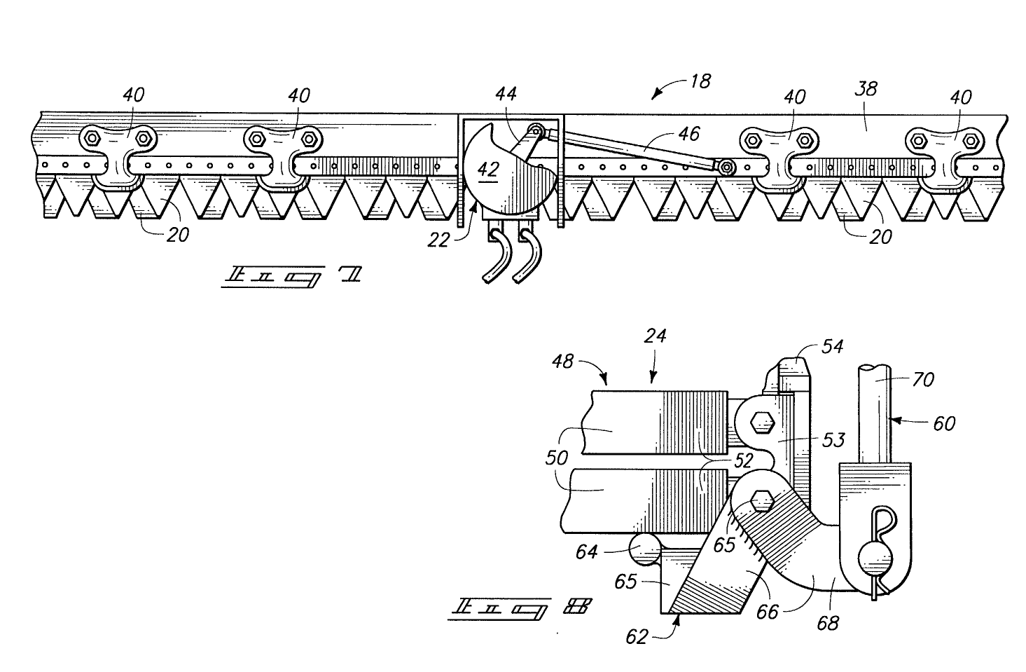

In one aspect of the present invention, a cutter bar and tillage implement 10 includes a frame 12 adapted at a forward end 13 for attachment to a vehicle 14 such as a farm tractor. A ground tillage tool 16 is mounted on the frame 12 along with at least one sickle bar 18 having reciprocal cutter teeth 20. A drive 22 (FIG. 7) is mounted to the sickle bar 18 and is operable to reciprocate the cutter teeth 20. A mount 24 secures the sickle bar 18 to the frame 12 forward of the ground tillage tool 16 such that vegetation may be cut by the sickle bar 18 for subsequent engagement by the ground tillage tool 16 as the implement 10 is moved in a forward direction.

In another aspect of the present invention, a cutter bar attachment 11 is provided for a tillage implement having a ground tillage tool 16 carried on a frame 12 for attachment to a vehicle 14 such as a farm tractor, in which the attachment 11 includes at least one sickle bar 18 having reciprocal cutter teeth 20. A drive 22 is mounted to the sickle bar 18 and is operable to reciprocate the cutter teeth 20. A mount 24 is also provided for securing the sickle bar 18 to the frame 12 forward of the ground tillage tool 16 such that vegetation may be cut by the sickle bar 18 for subsequent engagement by the ground tillage tool 16 as the implement is moved in a forward direction.

In another aspect of the present invention, the present invention includes a process for cutting and harrowing vegetation in a single pass through a field, including the step of attaching a frame 12 at a forward frame end 13 to a vehicle 14 such as a farm tractor. Other steps include providing a ground tillage tool 16 on the frame 12 and providing at least one sickle bar 18 having reciprocal cutter teeth 20 on the frame 12 forward of the ground tillage tool 16 and with a drive 22 that is operable to reciprocate the cutter teeth 20. Another step includes moving the vehicle 14 in a forward direction while reciprocating the cutter teeth 20 to cut vegetation such that cut vegetation is exposed to and is engaged and fractured by the ground tillage tool as the vehicle is moved in the forward direction.

Detailed Description

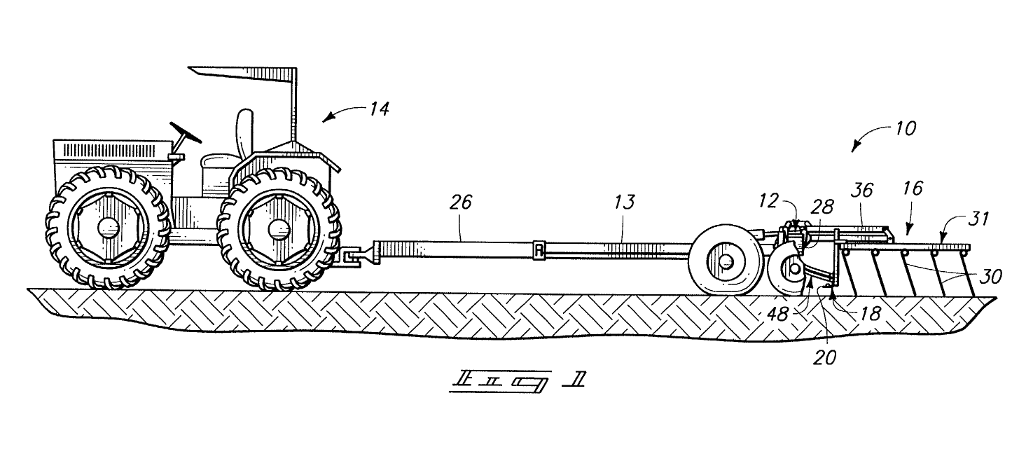

Referring now in greater detail to the drawings, attention is first directed to FIG. 1. There, a preferred form of the present implement 10 is shown attached to a vehicle or tractor 14 by means of the implement frame 12. The frame is preferably formed of rigid tubing or beams that are welded or otherwise fabricated in a “T” configuration with a tongue 26 extending from a cross bar 28 to the tractor 14. The cross bar 28 may be rigid or, more preferably, be foldable in a known manner to accommodate road travel and storage. Actual construction of the frame may vary according to the form of tillage tool used and the overall size of the implement.

The tillage tool 16, as exemplified in the drawings is preferably a harrow. Other forms may be used but in the example illustrated, the harrow is of the spring tooth variety. Spring tines 30 are mounted to a sub-frame 31 that is attached to and is pulled behind the cross bar 28. The individual tines are arranged in transverse and longitudinal spaced relation with respect to the forward direction of travel.

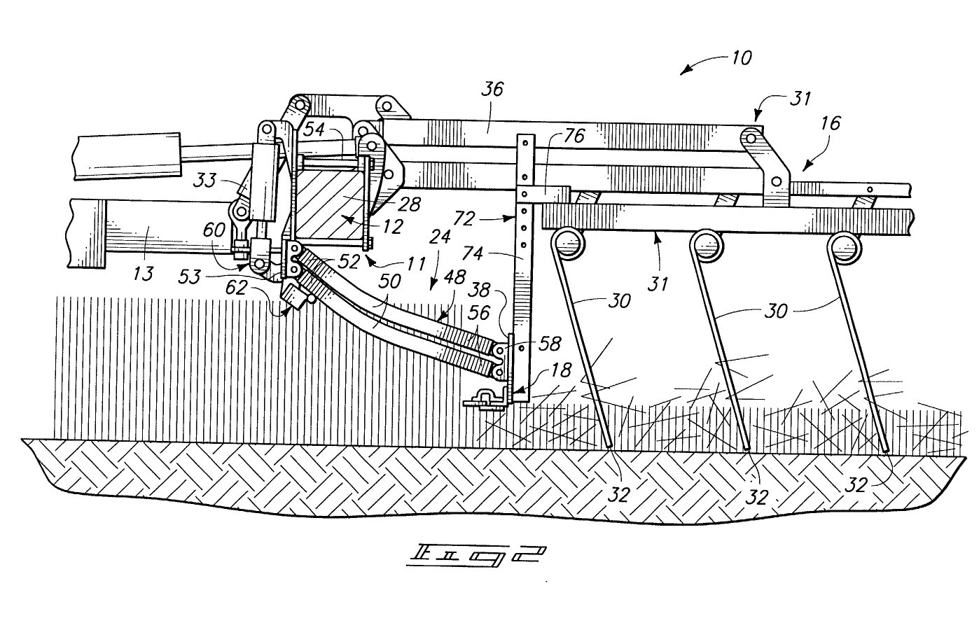

In the illustrated example, tines 30 individually extend to earth engaging ends 32 (FIG. 2) that may be elevationally adjusted by a linkage 36 connected between the sub-frame 31 and cross bar 28. A hydraulic ram or another appropriate lift mechanism 33 may be used between the linkage 36 and frame 12 to selectively raise or lower the tines with respect to the ground surface, and (if desired) to apply downward force against the tines when the implement is in operation.

In preferred forms, one or more sickle bars 18 are mounted to the frame 12 forward of the tillage tool 16 and to cut vegetation or stubble ahead of the tines as the implement is pulled in a forward direction. The cut vegetation is thus confronted by the tines, where many if not most of the stalks will be bent and fractured.

Two sets of reciprocating cutter teeth 20 (FIG. 7) make up the sickle bar. One set of the teeth is stationary, mounted to an elongated bracket 38 relative to the remaining set. Drive 22 operates the remaining set of teeth to slide in a transverse reciprocating motion over the relatively stationary tooth set, thereby effecting a “scissors” cutting action across the width of the implement 10. Guides 40 may be provided in spaced relation along the bracket 38 to retain the movable set of cutter teeth in sliding relation to the stationary teeth.

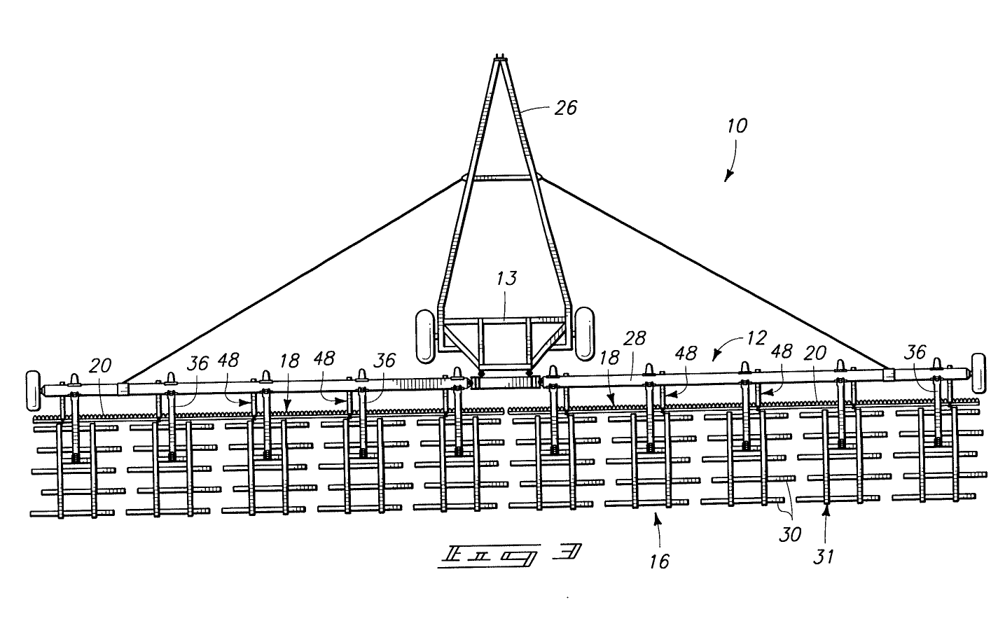

Actually several sets of teeth and several drivers may be provided, according to the overall operating width dimension of the implement. FIG. 3 shows an exemplary embodiment in which two pairs of sickle teeth sets are mounted on the implement in alignment across the width of the implement. Mounting the sickle teeth sets in pairs as shown allows for the individual pairs to be mounted to foldable parts of the cross bar 28, thereby facilitating folding of the implement to a narrower width for road transport.

The illustrated driver, shown in FIG. 7 may be provided in the form of a motor 42 with a bellcrank 44 and connecting rod 46 leading to the movable set of sickle teeth. Rotation of the bellcrank 44 will be translated to linear translational motion of the sickle teeth.

It is noted that other forms of drivers might also be used. For example, the sickle cutting action could be effected mechanically through a transmission (not shown) connected to a ground engaging wheel (also not shown) much in the manner of known forms of sickle cutters. It is preferred, however, that the motor drive be provided to afford the implement operator a selection of sickle tooth cutting speed that is independent of the forward speed of the implement 10. The motor drive is also not dependent upon traction of a driver wheel against the ground surface.

A preferred embodiment of the mount 24 may best be understood with reference to FIGS. 4-6. In the illustrated example, the mount 24 may be provided in the form of a retractable linkage 48 formed preferably by parallelogram bars 50 that may be pivotably mounted to the sickle bar 18 and frame 12 to maintain the sickle bar 18 in a substantially horizontal attitude. Top ends 52 of the parallel bars may be pivotably mounted by brackets 53 to exemplary shackle fitting assemblies 54 that securely clamp the brackets to the frame, specifically the cross bar 28.

Bottom ends 56 of the bars 50 are pivotably mounted by brackets 58 to the sickle bar mounting bracket 38. Pivot points at the ends 52, 56 are preferably arranged in parallel, substantially vertically oriented pairs with equal spacing so the bracket 38 will be carried in a horizontal attitude regardless of its elevational position (compare FIGS. 4-6). Thus the sickle bar 18 will also be maintained in a horizontal attitude.

Elevational positioning (extension and retraction) of the sickle bar 18 and linkage 48 may be selectively effected by the mount 24 through a lift actuator 60, an example of which is illustrated in FIGS. 4-6 and 8. The exemplary lift actuator 60 is connected to the linkage 48 and is configured to be attached to the tillage implement by way of the shackle fitting assemblies 54.

As may be noted in the illustration in FIG. 8, a part of the mount 24 and actuator 60 may be comprised of a loose link connection 62 having a stop 64 positioned to allow selective elevational movement of the sickle bar 18. The downward aspect of such motion is limited by a hanger assembly 72 which may be considered as a portion of the loose link connection 62 that is used to carry the sickle bar on the harrow sub-frame 31 when the harrow is in a ground engaging operative position (see FIG. 2).

The stop 64 may be situated at an end 65 of a rocker arm 66 that in turn is pivotably mounted at 65 to an associated shackle fitting 54. An opposite end 68 of the rocker arm 66 may be connected to actuator 60 such as the exemplary ram cylinder 70 shown in FIGS. 4-6 and partially shown in FIG. 8.

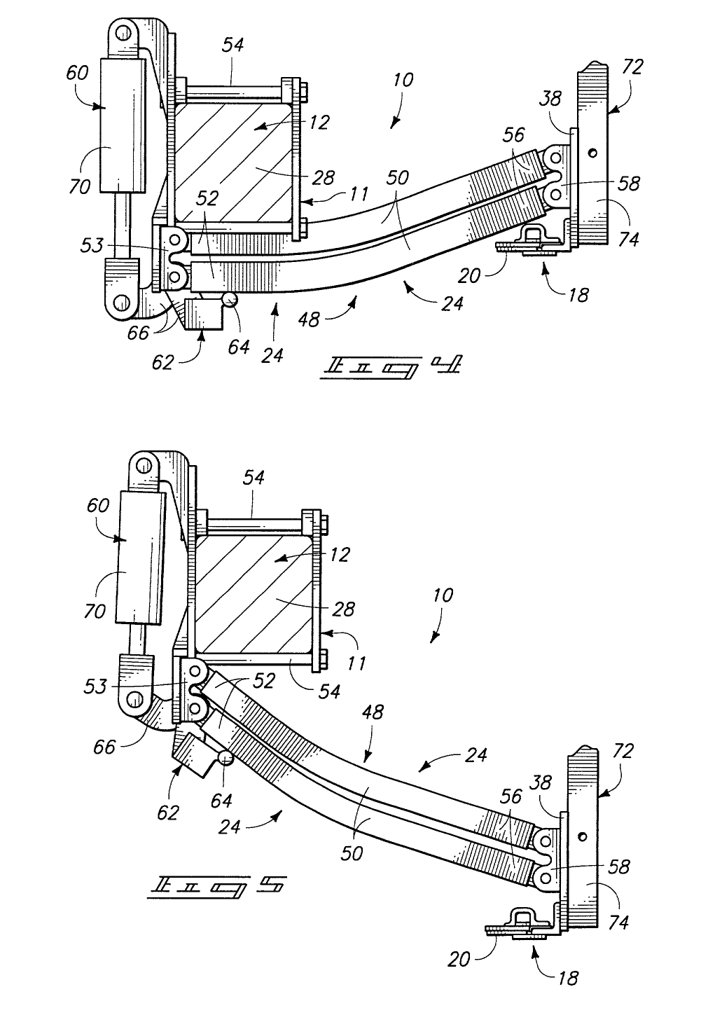

Extension and retraction of the cylinder 70 will cause pivotal or rocking motion of the stop and allow for corresponding elevational movement of the associated sickle bar 18 in an upward direction, or downwardly to the limit set by the cutter hanger assembly 72. Extension and retraction of the cylinder 70 and the resulting motion of the cutter bar is shown by comparing FIGS. 4 and 5. Extension of the cylinder 70 is shown to cause the stop 64 to lift the sickle bar 18. Retraction of the cylinder 70 causes the stop 64 to swing downwardly, lowering the sickle bar 18 to a point where the hanger 72 comes into contact against the harrow sub-frame 31 (FIG. 2) and the sickle bar becomes suspended from the harrow frame.

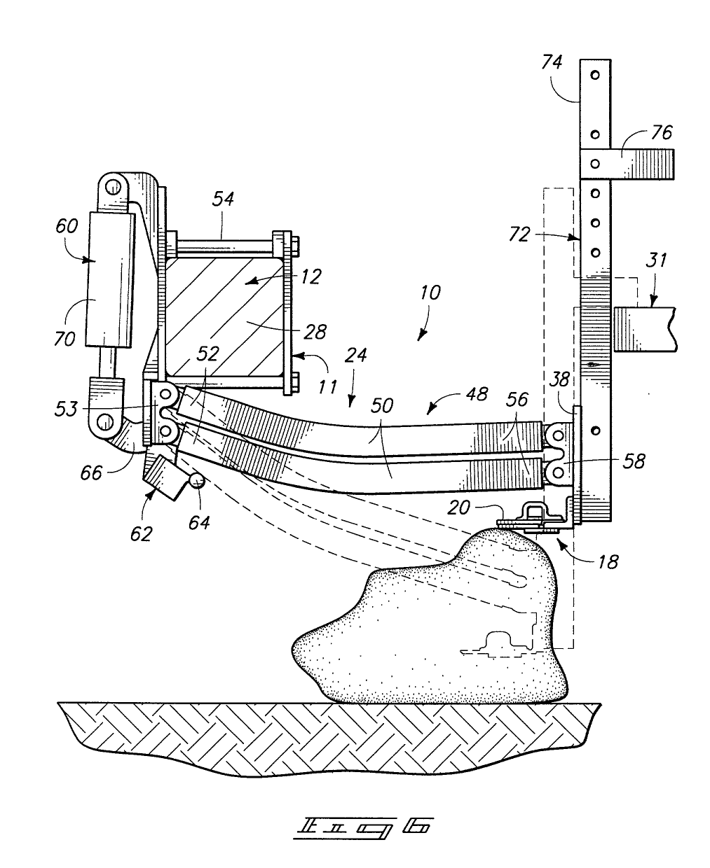

The hanger 72 may best be understood with reference to FIG. 6. In a preferred form, the hanger 72 includes at least one post 74 that is affixed at a bottom end to the sickle bar bracket 38. A stop 76 is adjustably mounted on the post 74 for releasably engaging the harrow sub-frame 31. As shown by dashed lines in FIG. 6, when the sickle bar 18 is in a down and operative position, the stop 76 is resting against the harrow sub-frame 31 so the sickle bar is essentially carried by the harrow. This operative position is also shown in FIG. 2. However, if an obstacle is encountered, the sickle bar 18 may swing upwardly as shown by solid lines in FIG. 6, where the stop 76 is spaced above the sub-frame 31. It may thus be understood that the sickle bar may be allowed to “float” above a level set by the position of stop 76 along the post 74, and the operating height of the sub-frame 31.

It is pointed out that the stop 64 is preferably provided independently of the linkage 48, and that the bars 50 carrying the sickle bar 18 simply rest on the stop 64 (as opposed to being affixed). This also allows the sickle bar 18 to move upwardly should an object be encountered as shown (in exaggerated circumstances) by FIG. 6. Thus the actuator 60 may be selectively used to raise or lower the sickle bar 18, but the bar itself will remain free to swing upwardly, should such a need arise, independently of actuator operation.

It is also pointed out that the present invention may be provided as a complete implement 10 in which the sickle bar 18 and tillage tool 16 are manufactured and sold as a unit, or as an attachment 11 in which the sickle bar and attached components may be provided for attachment to an existing tillage tool. In either form (assembly or sub-assembly) field operation of the invention and the process steps for cutting and fracturing vegetation in a single pass through a field will be similar.

Operation of the present invention may be understood in terms of the present process steps generally recited above.

To initiate operation (assuming the implement 10 has previously been provided with the ground tillage tool and sickle bar on the frame), the user may attach the unit to a towing vehicle such as the tractor 14 using an appropriate conventional hitch mechanism (not shown). The drive 22, lift mechanism 33, and lift actuator 60 may also be connected at this time to appropriate conventional controls and power source (also not shown) conventionally provided by the vehicle 14.

Next, the user may operate appropriate conventional controls to cause the lift mechanism 33 and lift actuator 60 to lower the spring tines 30 and sickle bar 18 into lowered operative positions. Preferably, the tines 30 are lowered to a point where the ends 32 engage the ground surface. Further adjustments may be made using the lift mechanism 33, to apply selective down pressure on the tines.

The sickle bar 18 may be similarly lowered to an elevation somewhat above the ground surface substantially as shown in FIG. 2, by reason of the hanger stop 76 resting on the harrow sub-frame 31. As the sub-frame is lowered, so will the sickle bar be lowered; so long as the loose link stop 64 is pivoted downwardly clear of the bars 50.

The selected cutting height may be varied according to ground conditions, the height of the stubble, or other conditions considered by the operator. If a change in cutter height is desired, the lift actuator 60 may be operated to lift the sickle bar and the hanger 72 upwardly as shown in FIG. 4. The weight of the sickle bar is now borne by the stop 64 and the hanger stop 76 is easily accessible to be disengaged and adjusted up or down the post 74 to determine a desired cutting height. Once the desired cutting height is selected, the hanger stop 76 is re-affixed to the post 72. The lift actuator 60 may next be operated to lower the sickle bar to a point where the stop 72 once again rests on the harrow sub-frame 31.

Once the above working heights have been selected, the operator may activate the drive motor 42, again by use of appropriate conventional controls, to start the cutting action of the sickle bar 18. The motor 42 will cause the cutting teeth 20 to reciprocate in a scissors action.

The user may now operate the vehicle to move forwardly. As the implement 10 is pulled forwardly, the reciprocating cutter teeth 20 will cut through the vegetation. Cut stalks will fall behind the sickle bar to be engaged by the spring tines 30 (see FIG. 2). The forwardly moving tines will fracture stalks substantially as graphically shown by FIG. 2. The fractured stalks will drop toward the ground surface where decomposition my naturally occur.

It is noted that the cutting and fracturing steps may be accomplished nearly simultaneously, and that the above operation may be accomplished in a single pass over the field.

In compliance with the statute, the invention has been described in language more or less specific as to structural and methodical features. It is to be understood, however, that the invention is not limited to the specific features shown and described, since the means herein disclosed comprise preferred forms of putting the invention into effect. The invention is, therefore, claimed in any of its forms or modifications within the proper scope of the appended claims appropriately interpreted in accordance with the doctrine of equivalents.

1. A cutter bar and tillage implement, comprising;
a frame adapted at a forward end for attachment to vehicle such as a farm tractor;
a ground tillage tool mounted on the frame;
a sickle bar having reciprocal cutter teeth;
a drive mounted to the sickle bar and operable to reciprocate the cutter teeth; and
a mount securing the sickle bar to the frame forward of the ground tillage tool such that vegetation may be cut by the sickle bar for subsequent engagement by the ground tillage tool as the implement is moved in a forward direction.

2. The cutter bar and tillage implement of claim 1, wherein the ground tillage tool is a harrow.

3. The cutter bar and tillage implement of claim 1, wherein the ground tillage tool is a spring tooth harrow.

4. The cutter bar and tillage implement of claim 1, wherein the sickle bar is mounted by a retractable linkage to the frame.

5. The cutter bar and tillage implement of claim 1, wherein the mount is comprised of retractable linkage adjustably mounted to the frame; and further comprising a lift actuator operable to selectively raise and lower the sickle bar independently of the ground tillage tool.

6. The cutter bar and tillage implement of claim 1, wherein the mount is comprised of a retractable linkage formed by parallelogram bars mounted between the frame and sickle bar to maintain the sickle bar in a substantially horizontal attitude; and further comprising a lift actuator connected between the linkage and frame.

7. The cutter bar and tillage implement of claim 1, wherein the mount is comprised of a retractable linkage connected between the frame and sickle bar to maintain the sickle bar in a substantially horizontal attitude; and further comprising a lift actuator connected between the linkage and frame with a loose link connection having a stop positioned to limit downward movement of the sickle bar.

8. The cutter bar and tillage implement of claim 1, wherein the ground tillage tool includes a sub-frame, and further comprising a hanger mounted to the sickle bar and positioned to engage and suspend the sickle bar from the sub-frame.

9. A cutter bar attachment for a tillage implement having a ground tillage tool carried on a frame for attachment to a vehicle such as a farm tractor, the attachment comprising:
a sickle bar having reciprocal cutter teeth;
a drive mounted to the sickle bar and operable to reciprocate the cutter teeth; and
a mount for securing the sickle bar to the frame forward of the ground tillage tool such that vegetation may be cut by the sickle bar for subsequent engagement by the ground tillage tool as the implement is moved in a forward direction.

10. The cutter bar attachment of claim 9, wherein the mount is comprised of a retractable linkage; and further comprising a lift actuator operable to selectively raise and lower the sickle bar.

11. The cutter bar attachment of claim 9, wherein the mount is comprised of a retractable linkage formed by parallelogram bars pivotably mounted to the sickle bar to maintain the sickle bar in a substantially horizontal attitude; and further comprising a lift actuator connected to the linkage and configured to be attached to the tillage implement.

12. The cutter bar attachment of claim 9, wherein the mount is comprised of a retractable linkage connected to the sickle bar and adapted to be connected to the tillage implement to maintain the sickle bar in a substantially horizontal attitude; and further comprising a lift actuator connected between the linkage with a loose link connection having a stop positioned to limit movement of the sickle bar.

13. The cutter bar attachment of claim 9, wherein the mount is comprised of a retractable linkage connected to the sickle bar and adapted to be connected to the tillage implement to maintain the sickle bar in a substantially horizontal attitude; and further comprising a lift actuator connected between the linkage with a loose link connection having a stop positioned to limit movement of the sickle bar, the stop being positioned to support the linkage at a selected elevation and to permit movement of the sickle bar from the selected elevation toward a retracted position.

14. The cutter bar attachment of claim 9, wherein the mount is comprise of a parallelogram linkage connected to the sickle bar and adapted to be connected to the tillage implement to maintain the sickle bar in a substantially horizontal attitude and further comprising a lift actuator connected to the parallelogram linkage with a loose link connection having a stop positioned to limit movement of the sickle bar , the stop being positioned to support the parallelogram linkage at a selected elevation and to permit movement of the sickle bar from the selected elevation toward a retracted position.

15. The cutter bar attachment of claim 9, further comprising a hanger mounted to the sickle bar and positioned to engage and suspend the tool.

16. A process for cutting and fracturing vegetation in a single pass through a field, comprising the steps of:
attaching a frame at a forward frame end to a vehicle such as a farm tractor;
providing a ground tillage tool on the frame;
providing a sickle bar having reciprocal cutter teeth on the frame forward of the ground tillage tool and with a drive that is operable to reciprocate the cutter teeth; and
moving the vehicle in a forward direction while reciprocating the cutter teeth to cut vegetation such cut vegetation is engaged and fractured by the ground tillage tool as the vehicle is moved in the forward direction.

17. The process of claim 16, wherein the step of providing a ground tillage tool is accomplished by providing a harrow on the frame.

18. The process of claim 16, wherein the step of providing a ground tillage tool is accomplished by providing a spring tooth harrow on the frame.

19. The process of claim 16, comprising the further step of permitting the sickle bar to move elevationally above a stop.

20. The process of claim 16, comprising the further step of permitting the sickle bar to move elevationally above a stop at an operative position, and comprising the further step of elevationally moving the sickle bar from the operative position to an elevated inoperative position.
